(19) United States
(12) Patent Application Publication
(10) Pub. No.: US 2018/0069400 A1
(43) Pub. Date: Mar. 8, 2018

(54) POWER SOURCE SYSTEM AND METHOD OF RESETTING POWER-ASSIST START POINT FOR THE SYSTEM

(71) Applicant: FUJI ELECTRIC CO., LTD., Kawasaki-shi (JP)

(72) Inventor: Kazuhiro IWAI, Tsuchiura (JP)

(73) Assignee: FUJI ELECTRIC CO., LTD., Kawasaki-shi (JP)

(21) Appl. No.: 15/811,566

(22) Filed: Nov. 13, 2017

Related U.S. Application Data
(63) Continuation of application No. PCT/JP2015/079237, filed on Oct. 15, 2015.

(51) Int. Cl. H02J 3/32; H02J 7/00

(52) U.S. Cl. CPC H02J 3/32; H02J 7/0068

(57) ABSTRACT

The power-source controlling apparatus sets a power-assist start point to an initial value, and obtains various types of measurement data via the current-value detecting unit and the power-value detecting unit, and stores the obtained data in the storage unit after linking the obtained data to time information from the clock unit. When the determined period of elapsed time is longer than a predetermined period, the power-source controlling apparatus resets the power-assist start point by evaluating the various types of measurement data associated with the predetermined period that have been linked to the time information stored in the storage unit.

### CROSS REFERENCE TO RELATED APPLICATION

This application is a continuation of the PCT application PCT/JP2015/079237 which was filed on Oct. 15, 2015, which was not published under PCT Article 21(2) in English.

### BACKGROUND OF THE INVENTION

### Field of the Invention

The present invention relates to a power source system that has a power-assist function to supply energy (power) from a battery unit to a load without affecting an input (commercial) power source when a momentary overloaded state occurs, and to a method of resetting a power-assist start point for the system.

### Description of Related Art

As long as the upper limit of an allowable overload is not exceeded, a typical power source system makes a request for an input (commercial)-power-source side to supply an exact power requested by a load side. This affects the input (commercial)-power-source side at least to some extent.

Hence, even if maximum power is needed for only a short time, a power contract needs to be made for the maximum power, thereby securing even as much power as would not be needed at ordinary times. Accordingly, for power contracts that enable a supply of maximum power, power leveling is not achieved.

In general, a power-assist function is recognized as a function to supply energy (power) from a battery to a load when load power has been generated that exceeds a certain threshold determined in advance, so as to achieve peak shifting to minimize the influence on the input (commercial)-power-supply side. The power-assist function has started to be used as a tool for achieving the power leveling described above.

Conventionally, power assist has been started and stopped in accordance with load power. Hence, when a point at which power assist is started (a load power value) is low, power assist frequently occurs, resulting in mass consumption of battery energy, and there has been a problem that sufficient backup power cannot be ensured when an abnormality (e.g., a blackout or momentary voltage dip) has occurred in a commercial power source.

Meanwhile, when a point at which the power assist is started (a load power value) is high, the power assist becomes less likely to be performed, leading to the conventional problem in which power leveling cannot be achieved even when the power-assist function is provided.

FIG. 1 is a block diagram illustrating the configuration of a conventional power source system disclosed by patent document 1. The conventional power source system depicted in FIG. 1 includes an AC power source 1, a load 2, power source units 3-5 that receive power from the AC power source 1 so as to supply an essentially constant voltage to the load 2, and battery units 6-8 that supply power from a built-in battery.

The power source units 3-5 and the battery units 6-8 are connected in parallel by a common DC bus-line.

The power source units 3-5 include AC/DC converting circuits 10-12 and DC/DC converting circuits 13-15 as components. In general, DC/DC converting circuits of an input-output isolation type are used as the DC/DC converting circuits 13-15.

The battery units 6-8 include batteries 16-18 and DC/DC converting circuits 19-21 as components. The DC/DC converting circuits 19-21 may either be insulation type circuits or non-insulation type circuits. The DC/DC converting circuits 19-21, which perform power conversion in one direction from the battery-unit side to the DC-bus-line side, also include measures for charging the battery (not illustrated), but may also be configured to further serve as charging circuits that are capable of performing power conversion in both directions.

The conventional power source system depicted in FIG. 1 is operated in a normal node, a backup mode, or an assist mode. In the normal mode, the power source units 3-5 supply power to the load 2.

In the backup mode, the battery units 6-8 feed power to the load 2 when the AC power source 1 has been interrupted.

In the assist mode, when the power to be supplied from the power source units 3-5 to a load runs short, the battery units 6-8 cover the shortage. For example, the assist mode may be set when the power of the load 2 has exceeded the total rated power of the power source units 3-5, when sufficient power cannot be supplied due to a decreased input voltage, even without an occurrence of a blackout, or when portions of the power source units 3-5 have been stopped due to a failure or maintenance.

In general, the voltage of a battery is decreased when discharging has occurred. The amount of decrease becomes greater as the discharge current becomes larger, or as the discharging progresses.

The DC/DC converting circuits 19-21 perform an operation to hold a voltage on the DC bus-line essentially constant irrespective of a change in the voltage of the battery.

The power source system depicted in FIG. 1 includes power source units 3-5 and battery units 6-8 connected in parallel to each other. To achieve a balance between the currents of the units, each unit is controlled according to what is called drooping characteristics.

As described above, when a blackout has occurred, the power source system disclosed in patent document 1 below, which includes a plurality of DC power source units connected in parallel, backs up the output lines of those units using a battery and controls the drooping characteristics of the power source units, so that a current that is equal to or greater than a rated current can be temporarily supplied. However, such a power source system is configured in a manner such that a point at which power assist is started (start point) is fixed or determined in advance by a report from a server or the like, and the point (start point) cannot be changed during operation.
Patent Document 1: WO2015/015570A1 (FIG. 2)

### BRIEF SUMMARY OF THE INVENTION

As described above, the point at which power assist is started (start point) cannot be changed during operation. Hence, depending on a change in the environment around the load or the setting of the point for the load at which power assist is started, a problem could possibly occur in which power assist is not started or power assist is frequently started, and this is undesirable for the power source system.

Accordingly, the present invention provides a power source system that is capable of appropriately changing, while the power source system is in operation, a point at which power assist is started (a power-assist start point), and a method of resetting the power-assist start point for the system.

The present invention is configured such that a power source system includes a power-source controlling apparatus that applies AC/DC conversion to input commercial power to supply DC power to a loading apparatus. The power-source controlling apparatus includes at least an AC/DC converting unit that supplies DC power to the loading apparatus, a charging-discharging unit that charges a battery upon receipt of an output of the AC/DC converting unit and that supplies power discharged from the battery to the loading apparatus, a controlling apparatus that obtains measurement data by detecting a current value and a power value for a DC bus connected to the loading apparatus, that stores the measurement data in a storage unit along with clock information, and reports a power-assist start point to a power-assist controlling unit so as to start power assist, and a power-assist controlling unit that supplies an output of the battery to the loading apparatus according to the report of the power-assist start point from the controlling unit, and that manages starting/stopping of power assist by detecting a current value for the DC bus. The controlling apparatus evaluates, according to the measurement data stored in the storage unit, the behavior of the power assist seen in a predetermined period and resets the power-assist start point for a next predetermined period.

A method of resetting a power-assist start point of the invention is directed to a power source system that includes a power-source controlling apparatus that applies AC/DC conversion to input commercial power to supply DC power to a loading apparatus. The power-source controlling apparatus has a current-value detecting unit, a power-value detecting unit, a clock unit, and a storage unit provided therein in advance. The method comprises: setting a power-assist start point to an initial value; obtaining various types of measurement data via the current-value detecting unit and the power-value detecting unit, and storing the obtained data in the storage unit after linking the obtained data to time information from the clock unit; and determining, according to the time information from the clock unit, a period of elapsed time after power assist has been started. The method further comprises, when the determined period of elapsed time is longer than a predetermined period, resetting the power-assist start point by evaluating the various types of measurement data linked to the time information stored in the storage unit.

Embodiments of the invention make it possible for a point at which power assist is started to be appropriately reset according to load power or statistical data, such as the period of power assist and the number of times power assist is performed, so that power assist can be operated effectively, thereby allowing an installed power source system to be operated efficiently.

When the rated capacity of a load has been changed due to, for example, a change in the power source system, the power-assist start point is automatically reset. Hence, a maintenance person does not need to set the power-assist start point on every occasion.

### BRIEF DESCRIPTION OF THE DRAWINGS

FIG. 1 is a block diagram illustrating the configuration of a conventional power source system described in patent document 1;

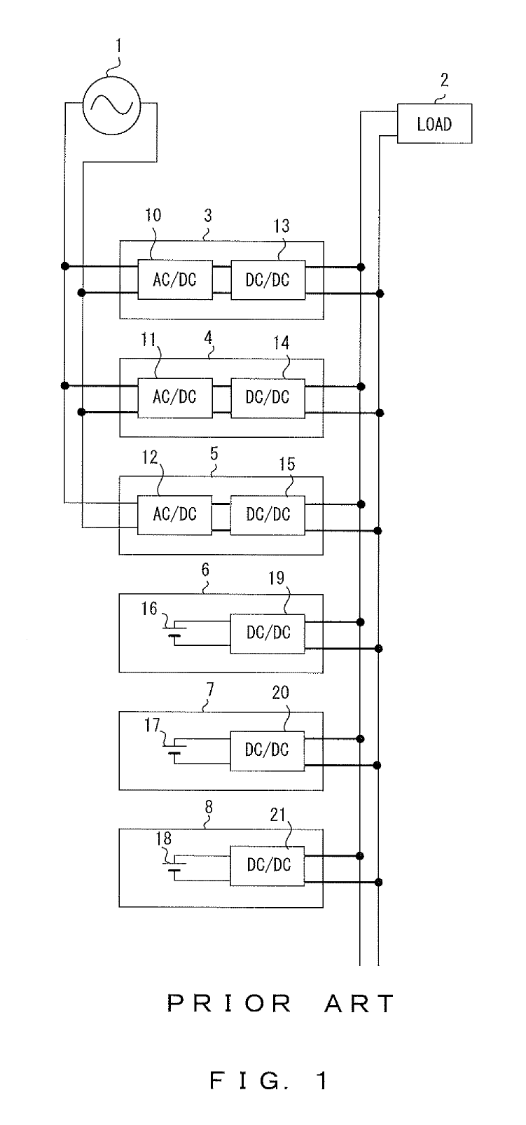

FIG. 2 is a block diagram illustrating the overall configuration of a power source system in accordance with an embodiment of the present invention;

FIG. 3 illustrates details of the configuration of a power-source controlling apparatus depicted in FIG. 2;

FIG. 4 is a conceptual diagram of the sharing of output in the case of a power-assist operation in accordance with an embodiment of the invention;

FIG. 5 is a conceptual diagram of the resetting of a power-assist start point in accordance with an embodiment of the invention; and

FIG. 6 is a flow diagram illustrating an operation of resetting a power-assist start point in accordance with an embodiment of the invention.

### DETAILED DESCRIPTION OF THE INVENTION

The following describes best modes for carrying out the invention by referring to the drawings.

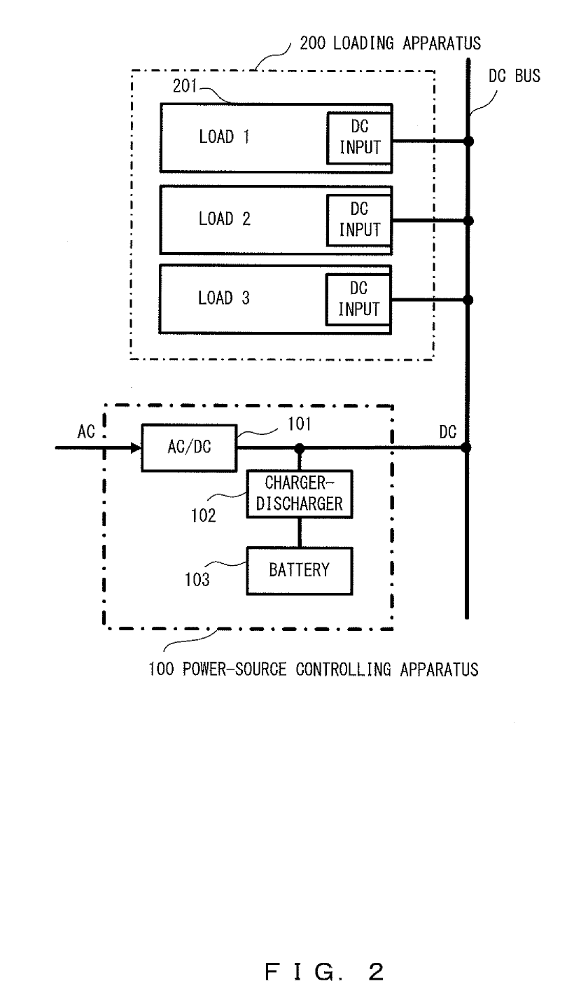

FIG. 2 is a block diagram illustrating the overall configuration of a power source system in accordance with an embodiment of the invention. In FIG. 2, the power source system in accordance with an embodiment of the invention includes a power-source controlling apparatus 100, a loading apparatus 200, and a DC bus (DC bus-line) connected to the power-source controlling apparatus 100 and the loading apparatus 200.

The power-source controlling apparatus 100 includes: an AC/DC converter 101 that converts an alternating current (AC) supplied from an AC power source (not illustrated) into a direct current (DC) and supplies DC power to the loading apparatus 200 and a charger-discharger 102; a charger-discharger 102 that charges a battery 103 according to the DC power output from the AC/DC converter 101 and that supplies the DC power as “power assist” to the loading apparatus 200 via the DC bus in accordance with an instruction from a controlling apparatus (not illustrated); and a battery (battery unit) 103 that accumulates the DC power output from the AC/DC converter 101 and that supplies the accumulated DC power to the loading apparatus 200 via the DC bus according to power-assist control (this will be described hereinafter).

The loading apparatus 200 includes loads 1-3 each provided with a DC input unit coupled to the DC bus; in the illustrated example, only the load 1 is assigned reference numeral 201, and the loads 2 and 3 are assigned no reference numerals. The number of loads in the illustrated example is simply an example, and the invention is not limited to that number. The illustrated loads 1-3 are assumed to be servers.

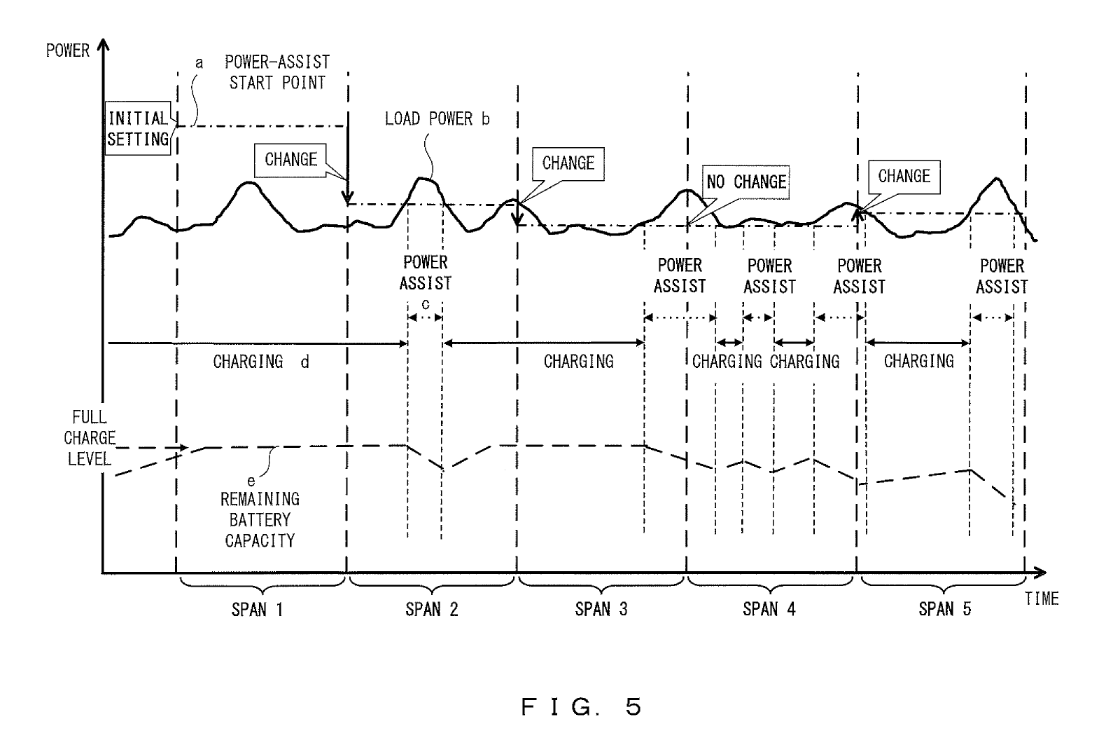

In a power source system that includes a server as a load, the power consumption is changed with the amount of information processed by the server (see the variation in load power b in FIG. 5). In the meantime, recent servers have provided therein a function related to control of power consumption so as to level the power consumption by limiting the maximum power used by the server, and this leads to a slightly long processing time but allows the power consumption at a peak time to be limited.

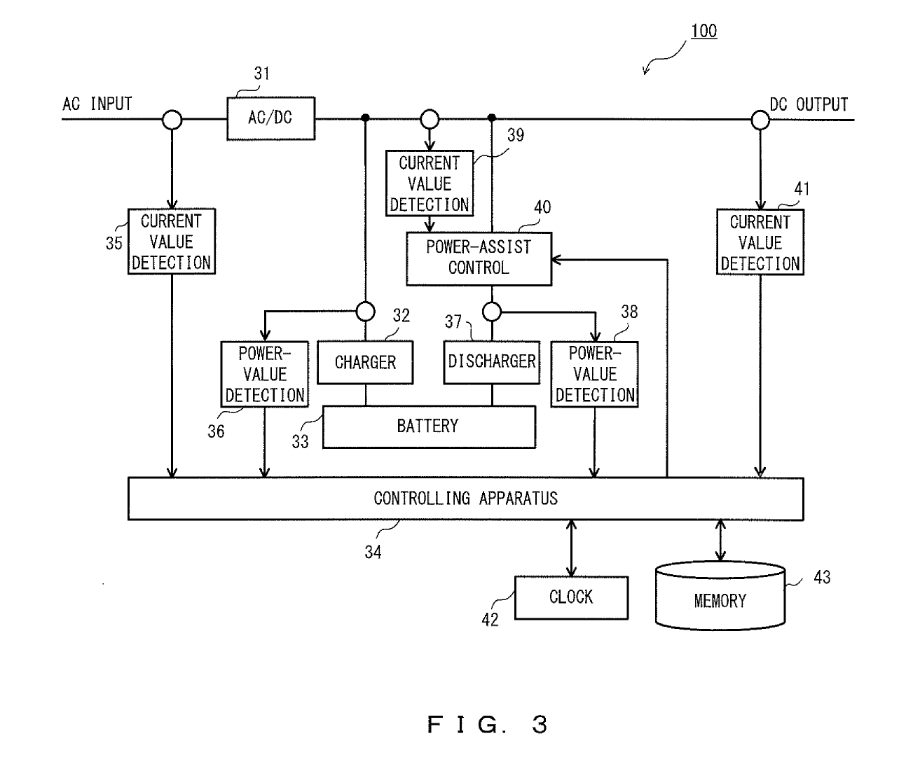

FIG. 3 illustrates details of the configuration of the power-source controlling apparatus 100 depicted in FIG. 2. In FIG. 3, the main components of the power-source controlling apparatus 100 in accordance with the embodiment of the invention are the same as those depicted in FIG. 2, including the AC/DC converting unit 31, the charger 32 and discharger 37, and the battery 33. In addition, the power-source controlling apparatus 100 further includes a controlling apparatus 34, a power-assist controlling apparatus 40, a clock unit 42, a memory 43, voltage-value detecting units 35, 39, and 41, and power-value detecting units 36 and 38.

The AC/DC converter 31 may include any type of AC/DC converter, including a rectifier circuit including one or more diodes, and preferably two or more diodes arranged to provide full-wave rectification of an AC signal. However, embodiments of the AC/DC converting unit 31 include any type of conversion circuit. The charger 32 and discharger 37 may be separate components or may be made up of the same components, including one or more capacitors and one or more switches, configured to provide power from a power source (AC/DC converting unit 31) to the battery 33 in a charging mode and discharge power from the battery 33 to a DC output in the discharging mode.
According to one embodiment, the controlling apparatus 34 includes one or more processors, memory, logic circuits, and programmable arrays, as well as other circuitry, to perform functions of receiving data from the current value detection units 35 and 41 and the power value detection units 36 and 38, as well as from memory 43, to analyze the received data, and to generate control signals to control the power-assist control unit 40 to control the power-assist operation of the power-source controlling apparatus 100.

The following describes functions achieved by components depicted in FIG. 3 by itemizing them.

(1) The current-value detecting unit 35 has a function to detect and report a current value of an AC input to the controlling apparatus 34. Hence, the controlling apparatus 34 can recognize a normal/abnormal state of an AC power source. Embodiments of the invention include any type of current-value detector, such as a Hall effect IC sensor, fluxgate transformer-type sensor, or any other sensor capable of detecting a current and generating an output according to the detected current.

(2) The power-value detecting unit 36 has a function to detect the value of DC power output from an AC/DC converting unit 31 so as to report to the controlling apparatus 34 the value of DC power supplied to a charger 32. A battery unit 33 in the figure is assumed to be a lithium-ion battery, and this battery is charged using a constant-current and constant-voltage charge (CCCV) method.

(3) The power-value detecting unit 38 has a function to detect the value of DC power output from a discharger 37 so as to report to the controlling apparatus 34 the value of the DC power output from the discharger 37. A battery unit 33 in the figure is assumed to be a lithium-ion battery, and a discharge current of the battery is preset according to the capacitance value of a cell that forms the battery.

(4) The current-value detecting unit 39 has a function to detect the value of a current output from the AC/DC converting unit 31 and the value of a current output on the DC bus so as to report those values to the power-assist controlling unit 40, which will be described hereinafter.

(5) The power-assist controlling unit 40 starts power assist according to a default power-assist start point designated by the controlling apparatus 34 and reports measurement data related to power-assist control to the controlling apparatus 34 via the power-value detecting units 36 and 38 and the current-value detecting units 39 and 41. The controlling apparatus 34 accumulates the reported measurement data in the memory 43, reads statistical data related to power assist performed in a certain period (e.g., one week) from the memory 43, and causes a computing unit (not illustrated) to perform computation based on a predetermined algorithm, thereby determining whether to change the power-assist start point for a next predetermined period. If necessary, the controlling apparatus 34 resets the power-assist start point of the power-source controlling apparatus 100 (see FIG. 2) so that the power assist that is the most effective for the power source system (see FIG. 2) can be achieved. This will be described in detail hereinafter.

In embodiments of the present invention, the power-assist controlling unit 40 includes one or more processors, programmable gate arrays, logic circuits, and other circuitry to receive and analyze the measurement data and to generate control signals to control the power assist start point. In one embodiment, the power-assist control unit 40 is entirely separate from the controlling apparatus 34, and in another embodiment, the power-assist control unit 40 includes one or more processors, memory, logic circuits or other electrical elements that are part of the controlling apparatus 34.

(6) The current-value detecting unit 41 has a function to detect the value of a current on the DC bus after a start of the power assist so as to supply the value to the controlling apparatus 34 as measurement data indicative of the behavior of the power assist that is seen at the power-assist start point.

(7) The clock unit 42 has a function to report to the controlling apparatus 34 time information for a time at which the controlling apparatus 34 reported the power-assist start point to the power-assist controlling unit 40, time information for a time at which the controlling apparatus 34 accumulates the current values detected by the current-value detecting units 35 and 41 in the memory 43, and time information for a time at which the controlling apparatus 34 accumulates the power values detected by the power-value detecting units 36 and 38 in the memory 43. Embodiments of the invention include any type of clock unit 42, including a counter having as an input a crystal oscillator.

(8) The memory 43 has accumulated therein measurement data, such as a current value and a power value reported to the controlling apparatus 34, that is associated with a certain period (e.g., one week), and statistical data such as time information for starting and stopping of power assist, so that the controlling apparatus 34 can evaluate the accumulated statistical data using a predetermined algorithm (this will be described hereinafter); the controlling apparatus 34 performs evaluation using the stored statistical data so as to reset the power-assist start point for a next predetermined period.

(9) The controlling apparatus 34 reads, from the memory 43, the statistical data related to the power-assist control performed in a predetermined period that has been accumulated in the memory 43 and performs computation using a predetermined algorithm, thereby evaluating the currently set power-assist start point; if necessary, the controlling apparatus 34 resets the power-assist start point for a next predetermined period so that the power assist that is the most effective for the installed power source system can be achieved. This will be described in detail hereinafter.

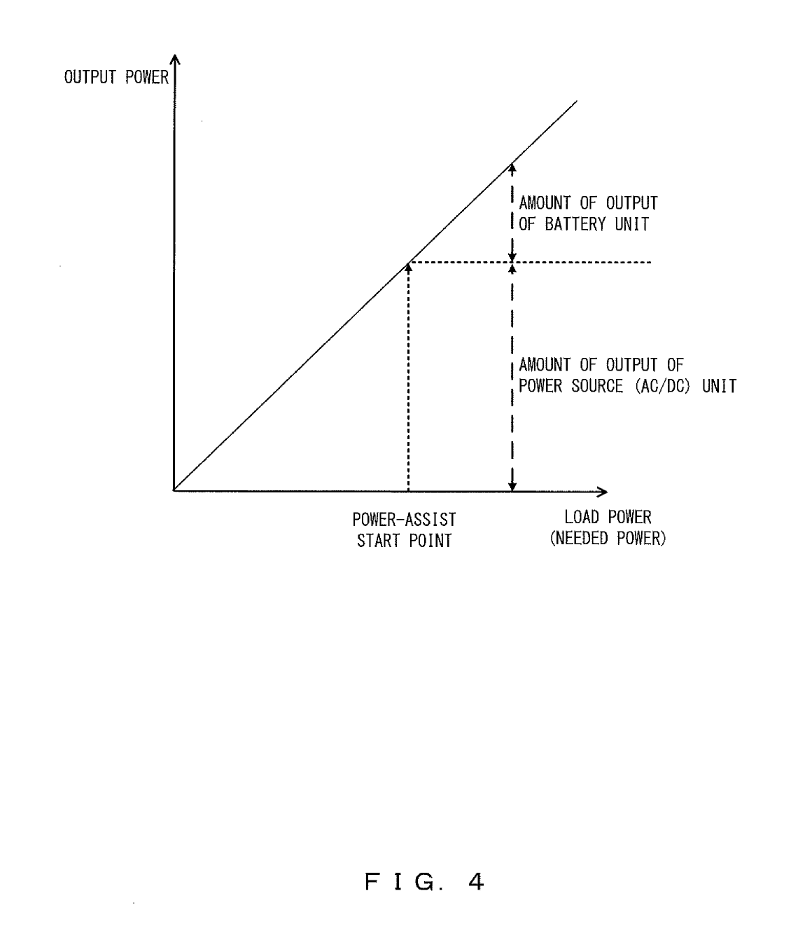

FIG. 4 is a conceptual diagram of the sharing of output in the case of a power-assist operation in accordance with an embodiment of the invention.

A power-assist start point illustrated in FIG. 4 is a point on load power that is a default point determined in activating the power source system. In the example of FIG. 4, the power-assist start point corresponds to the maximum value of the power output from the AC/DC converting unit 31 depicted in FIG. 3 before the start of power assist.

Accordingly, before the power assist is started, the sharing of output power in the installed power source system is carried out from the AC/DC converting unit 31 to the loading apparatus 200 (see FIG. 2) without the power output from the battery unit 33 in FIG. 3 being taken into consideration; when the power that the loading apparatus 200 needs to be supplied with has exceeded the power-assist start point, the battery unit 33 in FIG. 3 performs power assist for the loading apparatus 200 by supplying power.

The power-assist start point depicted in FIG. 4 is merely an example, and the invention is not limited to this. In particular, the power-assist start point may be set to a value that is lower than the maximum value of the DC power output from the AC/DC converting unit 31 depicted in FIG. 3, i.e., a value that is lower than the assist start point in FIG. 4.

In any case, when a power-assist start point has been exceeded, the power source system in accordance with the embodiment of the invention starts the supplying of DC power from the battery unit 33 to a loading apparatus; as will be described hereinafter, after the supplying of DC power has been started, the power source system obtains and saves statistical data related to power-assist control for a predetermined period, reads the saved statistical data, and evaluates the statistical data using a predetermined algorithm, thereby resetting the power-assist start point for a next predetermined period so that the power assist that is the most effective for the power source system can be achieved.

FIG. 5 is a conceptual diagram of the resetting of a power-assist start point in accordance with an embodiment of the invention. In particular, in the illustrated example, data that is obtained regarding a predetermined period (hereinafter referred to as a “span”) after the start of power assist is measured as the behavior of load power related to the power-assist start point, and the controlling apparatus 34 (see FIG. 3) evaluates the measured behavior of the load power using a predetermined algorithm (this will be described hereinafter) so as to reset the power-assist start point for a next predetermined period.

In FIG. 5, at the end of each of spans 1, 2, and 4, i.e., at the beginning of their next predetermined period, the power-assist start point is reset under a judgement of “a change needs to be made”.

In FIG. 5, a power-assist start point is indicated by power level a, which is, for example, a default represented by a one dot chain line in a predetermined period (span 1); the behavior of load power b is seen for a power-assist start point a; this behavior is evaluated using a predetermined algorithm (this will be described hereinafter), and, according to the result of the evaluation, the power-assist start point for the next predetermined period i.e., the power level for the next predetermined period, is changed.

Specifically, in span 1, power assist is not performed for the default power-assist start point a, and hence, at the start of the following span 2, the power-assist start point a is lowered under a judgement of “a change needs to be made”.

In span 2, power assist is performed in response to one occurrence of the load power b exceeding the power-assist start point a with resetting having been applied thereto in accordance with the result of the evaluation in span 1; however, this predetermined period still involves a difference between the power-assist start point a and the load power b, and hence the power-assist start point is lowered at the beginning of the following span 3 under a judgement of “a change needs to be made”.

In span 3, power assist is performed in response to load power b exceeding, at some portions of this predetermined period, the power-assist start point a with resetting having been applied thereto in accordance with the result of the evaluation in span 2, while load power b does not exceed that power-assist start point at the other portions of this predetermined period; this predetermined period is judged to involve almost no difference between the power-assist start point a and the load power b, and hence the power-assist start point a is maintained at the beginning of the following span 4 under a judgement of “a change does not need to be made”.

In span 4, power assist is performed in this predetermined period in response to load power b exceeding twice the power-assist start point a maintained in span 3, while load power b falls below twice that power-assist start point; however, this predetermined period is acknowledged as involving a difference between the power-assist start point a and load power b, and hence the power-assist start point is raised at the beginning of the following span 5 under a judgement of “a change needs to be made”.

In span 5, power assist is performed in this predetermined period in response to one occurrence of the load power b exceeding the power-assist start point a with resetting having been applied thereto in accordance with the result of the evaluation in span 4; this predetermined period is acknowledged as involving a larger difference between the power-assist start point a and load power b, and a remaining battery capacity e indicated at the lower portion of FIG. 5 is acknowledged as gradually decreasing in comparison with a full charge level. Accordingly, the power-assist start point can be raised at the beginning of the following span 6 (not illustrated) under a judgement of “a change needs to be made”. This is intended to prevent the battery unit 33 depicted in FIG. 3 from running out the power to be used for total backup of load power when AC input is not supplied (in case of a blackout).

The middle portion of FIG. 5 illustrates the battery unit 33 depicted in FIG. 3 being put in the state of power assist c and the state of charging d in an alternating pattern in comparison with the power-assist start point a of each predetermined period.

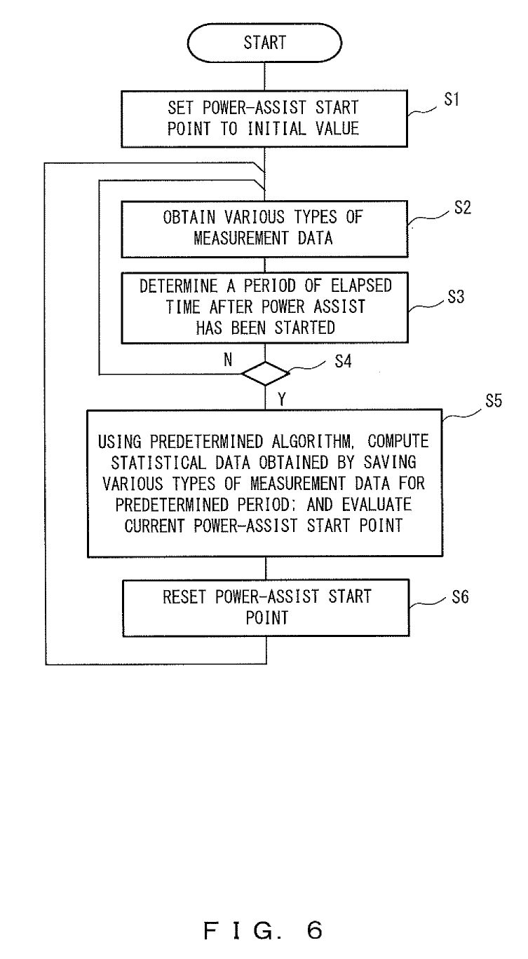

FIG. 6 is a flow diagram illustrating an operation of resetting a power-assist start point in accordance with an embodiment of the invention. In FIG. 6,

in step S1, a power-assist start point is set to an initial value (see FIG. 4),

in step S2, various types of measurement data are obtained via the power-value detecting units 36 and 38 and the current-value detecting units 39 and 41 depicted in FIG. 3, and

in step S3, a period of elapsed time after power assist has been started is determined.

In step S4, when the period of elapsed time determined in step S3 is shorter than a predetermined period (the span depicted in FIG. 5), the flow returns to step S2; otherwise, the flow shifts to step S5.

In step S5, statistical data obtained by saving the various types of measurement data described above for a predetermined period is computed using a predetermined algorithm, and a current power-assist start point that has been set is evaluated. This will be described hereinafter.

In step S6, the power-assist start point is reset according to the result of the evaluation from step S5.

As described above, in the resetting of a power-assist start point in accordance with the invention, the current power-assist start point is evaluated in computation performed using a predetermined algorithm according to statistical data associated with a predetermined period (the span depicted in FIG. 5), and the power-assist start point is reset for a next predetermined period. Resetting the power-assist start point several times for individual predetermined periods allows the most effective power assist to be achieved for the installed power source system.

The following describes an outline of an algorithm for resetting the power-assist start point of the power-source controlling apparatus described above. The algorithm for resetting the power-assist start point is changed with the environment of an installed power source system, and hence descriptions will be given of an outline of fundamental portions only.

Referring to FIGS. 2, 3, and 5, the following is an itemized outline of the algorithm for resetting a power-assist start point.

Referring to statistical data accumulated in the memory 43 regarding a predetermined period that has been obtained using the power-value detecting units 36 and 38 and the current-value detecting units 39 and 41 depicted in FIG. 3, a computing unit (not illustrated) of the controlling apparatus 34 depicted in FIG. 3 calculates, for each predetermined period (each span depicted in FIG. 5), the number of times power assist is performed, and an average power-assist duration; calculates, for each power-assist process, the amount of power supplied by the battery unit 33, the maximum and minimum values of the amount of power consumed by the loading apparatus 200 (see FIG. 2), and an average amount of power consumption; and accumulates the calculation results in the memory 43.

For each predetermined period (each span depicted in FIG. 5), the computing unit calculates an average time required to supply, via the charger 32, an equal amount of power as the power the battery unit 33 supplied to the loading apparatus 200 in power assist, and accumulates the calculation result in the memory 43.

(2) At the end of each individual predetermined period (each span depicted in FIG. 5), using the statistical data accumulated in the memory 43, the computing unit (not illustrated) of the controlling apparatus 34 depicted in FIG. 3 performs evaluation by referring to

the number of times power assist has been performed, and an average power-assist duration,

the following values calculated for each power-assist process: the amount of power supplied by the battery unit 33, the maximum and minimum values of the amount of power consumed by the loading apparatus 200, and an average amount of power consumption; and

the following value calculated for each predetermined period: an average time required to supply, via the charger 32, an equal amount of power as the power the battery unit 33 supplied to the loading apparatus 200.

According to the evaluation, the computing unit determines whether the power-assist start point needs to be reset for a next predetermined period.

By referring to FIG. 5, the following describes an example of the determining of whether a power-assist start point needs to be reset according to the result of the evaluation described above.

(a) When power assist is not performed within a predetermined period after power assist has been started at a currently set power-assist start point, or when the remaining capacity of the battery unit 33 after a start of power assist does not fall below a certain threshold (e.g., 90% of the battery capacity), the currently set power-assist start point is set to a low value (see, for example, spans 1 and 2 in FIG. 5). The low value is desirably determined by referring to statistical data on the installed power source system.

(b) When the difference between the maximum and minimum values of the amount of power consumed by the loading apparatus 200 (see FIG. 2) is not greater than a certain threshold (e.g., about 10% of the battery capacity), the power-assist start point is reset to the value of average power consumption of the loading apparatus 200 (see, for example, span 3 in FIG. 5).

(c) When it is likely that the power from the battery unit 33 that has been consumed in power assist cannot be compensated for (when the remaining battery capacity e indicated at the lower portion of FIG. 5 is acknowledged, as seen at the end of span 5, as sharply decreasing relative to the full charge level), the battery unit 33 depicted in FIG. 3 could be incapable of totally backing up the load power in case of a blackout, i.e., the power source system cannot work; accordingly, the power-assist start point is set to a high value. The high value is desirably determined by referring to statistical data on the installed power source system.

### INDUSTRIAL APPLICABILITY

The present invention is applicable in the power-supply field, generally, including the server described in the illustrated examples, and also to a power source apparatus for a large-scale computer and a power source apparatus for communication equipment.

What is claimed is:

1. A power-source controlling apparatus that applies AC/DC conversion to input commercial power to supply DC power to a loading apparatus, the power-source controlling apparatus comprising:
an AC/DC converting unit that supplies DC power to the loading apparatus,
a charging-discharging unit that charges a battery upon receipt of an output of the AC/DC converting unit and that supplies power discharged from the battery to the loading apparatus,
a controlling apparatus that obtains measurement data by detecting a current value and a power value for a DC bus connected to the loading apparatus and stores the measurement data in a storage unit along with clock information, and
a power-assist controlling unit that receives from the controlling apparatus a power-assist start point so as to start power assist according to the measurement data and that supplies an output of the battery to the loading apparatus according to the received power-assist start point from the controlling apparatus, and that manages starting/stopping of the power assist by detecting a current value of the DC bus,
wherein the controlling apparatus evaluates, according to the measurement data stored in the storage unit, a behavior of the power assist detected in a predetermined period and resets the power-assist start point for a next predetermined period.

2. The power source controlling apparatus according to claim 1, wherein
the controlling apparatus includes a computing unit that evaluates, according to the measurement data stored in the storage unit, the behavior of the power assist seen in the predetermined period, and
the computing unit calculates, for each predetermined period, a number of times the power assist is performed, and an average power-assist duration, and calculates, for each power-assist process, an amount of power supplied by the battery, maximum and minimum values of an amount of power consumed by the loading apparatus, and an average amount of power consumption.

3. The power source controlling apparatus according to claim 1, wherein
the controlling apparatus includes a computing unit that evaluates, according to the measurement data stored in the storage unit, the behavior of the power assist seen in a predetermined period, and
for each predetermined period, the computing unit calculates an average time required to supply, to the battery, an equal amount of power as the power the battery supplied to the loading apparatus in the power assist.

4. The power source controlling apparatus according to claim 1, wherein
the controlling apparatus includes a computing unit that evaluates, according to the measurement data stored in the storage unit, the behavior of the power assist seen in a predetermined period,
the controlling apparatus evaluates the behavior of the power assist seen in a predetermined period that has been calculated by the computing unit, so as to determine whether to change the power-assist start point for a next predetermined period,
when the controlling apparatus has determined that the change needs to be made, the controlling apparatus resets the power-assist start point, and
when the controlling apparatus has determined that the change does not need to be made, the controlling apparatus maintains the power-assist start point.

5. The power source controlling apparatus according to claim 1, wherein
the controlling apparatus detects a current value of input commercial power, and when a current value of the input commercial power is not detected, backs up power supply to the loading apparatus using the battery.

6. A method of resetting a power-assist start point for a power source system that includes a power-source controlling apparatus that applies AC/DC conversion to input commercial power to supply DC power to a loading apparatus, the power-source controlling apparatus including a current-value detecting unit, a power-value detecting unit, a clock unit, and a storage unit provided therein in advance, the method comprising:
setting a power-assist start point to an initial value;
obtaining various types of measurement data via the current-value detecting unit and the power-value detecting unit, and storing the obtained measurement data in the storage unit after linking the obtained measurement data to time information from the clock unit;
determining, according to the time information from the clock unit, a period of elapsed time after power assist has been started; and
when the determined period of elapsed time is longer than a predetermined period, resetting the power-assist start point by evaluating the various types of measurement data linked to the time information stored in the storage unit.

7. The method according to claim 6, wherein
resetting the power-assist start point by evaluating the various types of measurement data resets the power-assist start point by evaluating, for each predetermined period, a number of times the power assist is performed, and an average power-assist duration, and by evaluating, for each power-assist process, an amount of power supplied by the battery, maximum and minimum values of an amount of power consumed by the loading apparatus, and an average amount of power consumption.

8. The method according to claim 6, wherein
resetting the power-assist start point by evaluating the various types of measurement data resets the power-assist start point by evaluating, for each predetermined period, an average time required to supply, to the battery, an equal amount of power as the power the battery supplied to the loading apparatus in the power assist.
